(19) United States
(12) Patent Application Publication
(10) Pub. No.: US 2004/0122752 A1
(43) Pub. Date: Jun. 24, 2004

(54) System and method for time and attendance record keeping

(76) Inventors: William B. Horne, Marietta, GA (US); Dale E. Humphries, Suwanee, GA (US)

Correspondence Address: MCKENNA LONG & ALDRIDGE LLP, 1900 K STREET, NW, WASHINGTON, DC, 20006, US

(21) Appl. No.: 10/732,358

(22) Filed: Dec. 11, 2003

Related U.S. Application Data
(63) Continuation-in-part of application No. 10/118,310, filed on Apr. 9, 2002.

(51) Int. Cl. G06F 17/60

(52) U.S. Cl. 705/32

(57) ABSTRACT

A system and method for time and attendance record keeping includes receiving identifying information from an employee at a point-of-sale terminal; recording clock in data for the employee; recording clock out data for the employee; using the clock in data and the clock out data to produce a time record for the employee; and transmitting the time record to a host system via a communication network. The host system is accessible by a manager via the Internet or other similar platform so that the manager can print report and other manipulate the time and attendance records remotely through a personal computer or other Web enabled portable device. Moreover, the manager can access the time and attendance records at the POS device.

### BACKGROUND OF THE INVENTION

1. Field of the Invention

The present invention relates to a system and method for time and attendance record keeping. More particularly, the present invention relates to a system and method for collecting, reconciling, and processing labor resource information at a business location through an electronic transaction device such as the Hypercom ICE 5500, VeriFone OMNI terminals, Hypercom ICEPlus and T7Plus terminals, Lipman Nurit Terminals, Ingenico Elite Terminals, or the like.

2. Discussion of the Related Art

In business, it is necessary to track the attendance of employees for the purposes of compensation and evaluating performance. Traditionally, businesses have relied on stand alone time clocks to record employee information. The time clocks do not interface with other information systems that are colocated with the time clock. Businesses have separately purchased other equipment, such as point-of sale devices, that perform single functions or multiple functions, but do not integrate the time clock function.

The purchase of such multiple devices can be costly. Integrating multiple functions into a single device reduces costs and allows shared functionality, such as shared modems and memory functions.

### SUMMARY OF THE INVENTION

Accordingly, the present invention is directed to system and method for labor resource record keeping that substantially obviates one or more of the problems due to limitations and disadvantages of the related art.

An advantage of the present invention is to provide a system for collecting, reconciling, and processing labor resource information at a business location through an electronic transaction device.

Another advantage of the present invention is to provide a method for collecting, reconciling, and processing labor resource information at a business location through an electronic transaction device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of recording employee time records includes receiving identifying information from an employee at a point-of-sale (POS) terminal; recording clock in data for the employee; recording clock out data for the employee; using the clock in data and the clock out data to produce a time record for the employee; and transmitting the time record to a host system via a communication network.

In another aspect of the present invention, a system according to the present invention includes a point-of-sale (POS) terminal, an intermediate server, and a host server. The POS terminal includes a clock such that an employee may enter identification information into the POS terminal, clock in at the start of working, and clock out at the end of working. Upon request or automatically the POS terminal transmits the clock information to the host server through the intermediate server or to the host server directly if no intermediate server is used. The host server is accessible by a manager that can review employee time records and create reports, adjust time records or otherwise manipulate time and attendance information entered at the POS terminal.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram illustrating the relationship of components of a system of recording labor resource information according to the present invention.

FIG. 2 is a diagram illustrating the connectivity of components of a system of recording labor resource information according to the present invention.

FIG. 3 is a schematic diagram of an exemplary point-of-sale (POS) device for use as a component of the system of recording labor resource information according to the present invention.

### DETAILED DESCRIPTION OF THE ILLUSTRATED EMBODIMENTS

Reference will now be made in detail to an embodiment of the present invention, example of which is illustrated in the accompanying drawings.

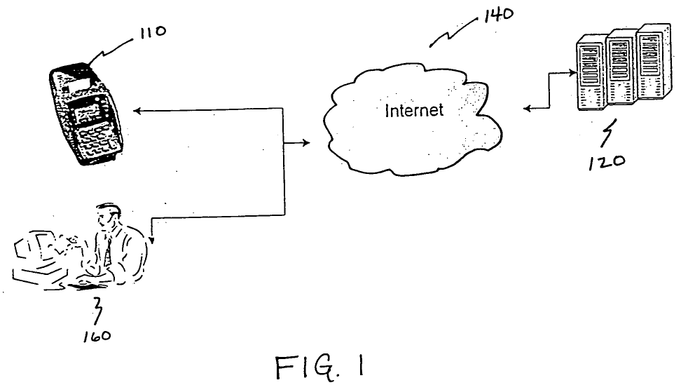

As shown in FIG. 1, according to the present invention, a local device 10 at a business location is capable of receiving information from an employee or about an employee for recording or transmitting time and attendance or other labor resource information. This local device 110 is capable of communicating with a host system 120 via an electronic communications network, including, for example, the Internet 140 or via a modem or other similar connection directly to the host system 120. For example, the local device may offer a direct Internet connection. Various databases or other storage capability may be used to record the labor resource information about an employee or a plurality of employees in the local device 110 or host system 120 or both. Management personnel 160 or automated systems access the host system 120 through any of a variety of different connection types, including via an Internet Web Site, to review, record, collate, compile and manipulate the labor resource information.

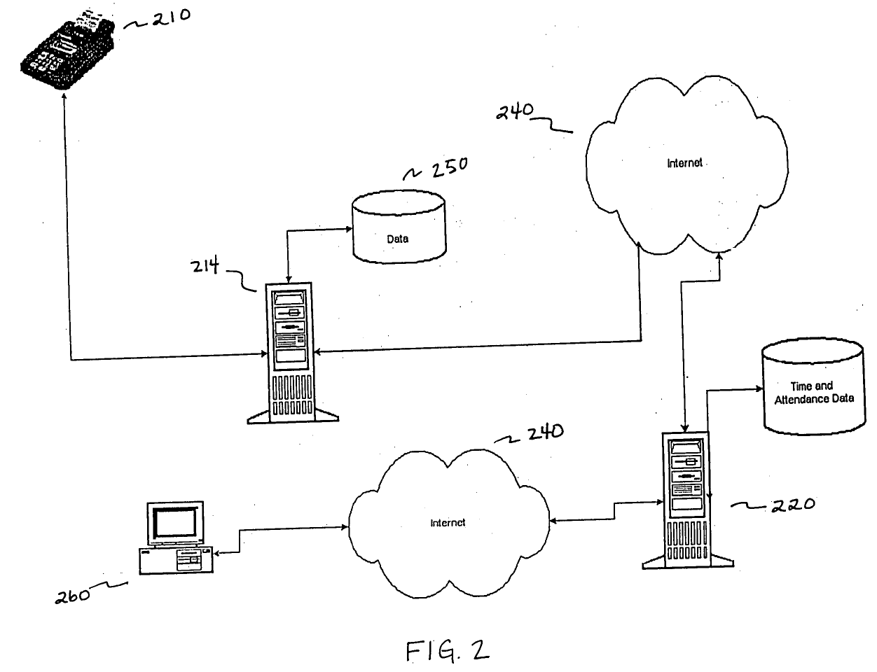

As shown by example in FIG. 2, a first embodiment of the present invention includes a local device 210 that is capable of communicating to an intermediate server system 214. The intermediate server system 214 connects to the Internet 240. The intermediate server system 214 communicates via the Internet 240 to a host system 220, which also connects to the Internet 240. An end user 260 may connect to the host system 220 via an Internet Web Site (not shown) via a browser. The Internet Web Site interface may include a graphical user interface (GUI) or user friendly interface to allow the end user 260 to access labor resource information that that user has authorization to access. For example, an employee may be able to access labor resource information pertaining only to him, for example, his hours worked during a pay period. Typically, an employee would have very limited access to labor resource data, if any access at all.

In contrast, a manager or owner of a business may have a great deal of access to labor resource information. For example, a manager may access the host system 220 via an Internet browser and the Internet Web Site to add/edit employees, add/edit department information, add/edit pay code information, fix missing punches, add hours to time cards, request reports, and update processing parameters. A variety of tools may be made available to the manager or owner via any of a variety device portals including a personal computer, personal data assistant, “point-of-sale” (POS) terminals and cell phones. The system may include a minimally distributed database for verifying employee name and other identifying information. At least a portion of the database may be stored on the local device 210, which may be backed up by the host server 220.

The local device 210 may include any of a plurality of devices used in a business setting for electronic transactions, often referred to as POS terminals. In at least one embodiment of the present invention, the POS terminal includes a printer so that labor resource records may be printed at the business location by the point-of-sale terminal. Such point-of-sale terminals include cash registers and electronic payment authorization devices, including those for use with credit cards, debit cards, smart cards, and biometric data, whether stand alone or Internet-based. Other possible local devices include personal digital assistants (PDAs) or similar hand held devices; cellular telephones; personal computers; smart card devices; telephones, including those equipped with interactive voice response systems; media devices with a communications ports such as telephone modems, cable modem, and DSL modems; devices with embedded software operating systems; electronic purse applications; license issuance devices; customer loyalty applications, etc.

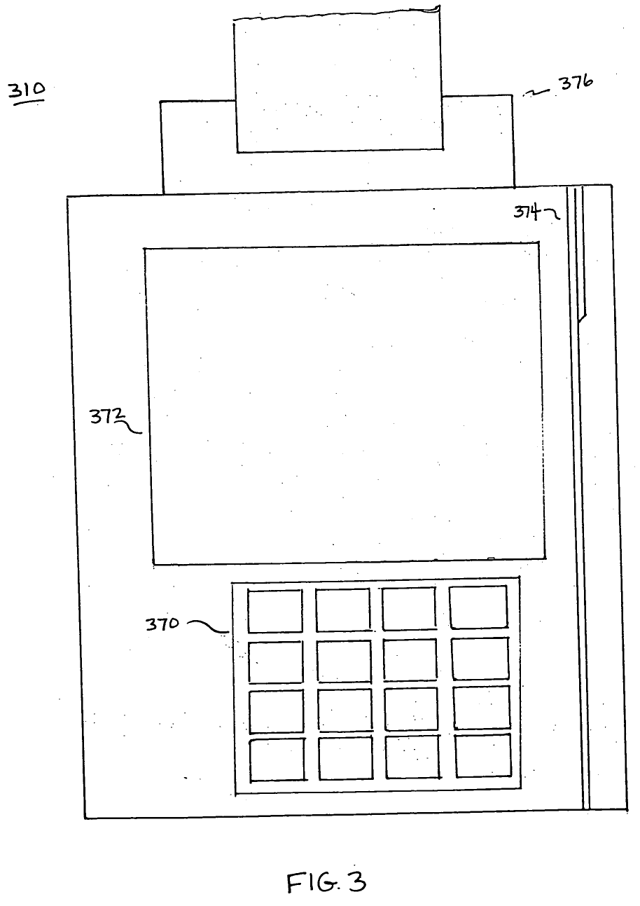

An example of one type of POS terminal 310 is shown schematically in FIG. 3. The POS terminal may include any of a variety of inputs including a numeric key pad 370, an alphabetic key pad (not shown), a display screen 372, which may be a touch screen, a magnetic card reader 374 (e.g., card swipe) and a signature capture pad (not shown). The POS terminal may include a printer 376. As discussed above, the POS terminal or local device communicates with the Internet, perhaps through the intermediate server 214. Therefore, the POS terminal includes a communications port (not shown) such as a dial-up modem, T1 line, wireless or other similar connection for connecting to the intermediate server or the Internet through another method. In addition, the POS terminal includes a memory for storing information received via any of the inputs to the POS terminal. Also, the POS terminal 310 includes a clock (not shown). The clock may be synchronized with and/or backed up by the host server 220.

A method of using the system according to the present invention will now be described with reference to FIG. 2.

Upon starting a shift, an employee accesses the POS terminal 210 by any of a variety of means including swiping or scanning a card containing identifying information or manually punching in identifying information such as the employee's name, a unique code number and/or a social security number or portion of the social security number, for example, the last four digits, into the keypad or touch screen of the POS terminal 210. The employee may enter additional identifying information such as a store code or department code identifying the location and department in which he will be working during his shift. Upon ending a shift, the employee accesses the POS terminal 210 as he did upon starting his shift. The employee may also print a time card showing his clock in and clock out information for a specific day in the current week or week-to-date, total hours, missing data, managerial adjustments to the time recorded or the like when he accesses the POS terminal.

When an employee accesses the POS terminal 210, the POS terminal 210 verifies the employee's identifying information. The POS terminal 210 accepts employee “punch ins” at the start of an employee's shift and “punch outs” at the end of an employee's shift and records the times of the punch ins and punch outs according to the clock. The POS terminal 210 may also include software to round the clock times recorded for a punch in or punch out, and the duration of the period therebetween to the nearest minute, tenths of hours, quarter hours, or the like as best suited for a particular business. A database in memory (not shown) or other convenient data storage structure stores the employee shift information (e.g., time and attendance records). The employee shift information may be stored in a database in memory.

In one embodiment of the present invention, the memory stores punch in time and punch out times as individual transactions. Only during the printing of time card would the POS terminal 210 associate a punch in with a punch out. Employee punch ins and punch outs may be stored by POS terminal 210 sequentially so that reading from start to finish will reflect the sequence of events as they actually occurred. Optimally, the punches in and out by an employee would start with a punch in followed by a punch out or associated with a punch out. In reality, an employee may forget to punch in or punch out, or may mistakenly repeat a punch in or punch out. The POS terminal 210 may identify such mistaken punches. Similarly, an employee may punch in at the start of one shift, forget to punch out at the end of that shift, forget to punch in at the start of the next shift, but finally punch out at the end of the next shift. In this example, the span of time between the successive punch in and punch out times would be unusually large. In this case, the POS terminal 210 may identify the entries as mistaken punches.

The POS terminal 210 may store only a limited amount of employee shift information, for example, only one week's worth of information. However, there may be a short period of time at the beginning of each week when employees may be punching in for the new week, while data from the previous week is still in the POS terminal's memory. Such circumstances may occur when the manager delays closing the payroll for the previous week. The POS terminal 210 and database in memory may be configured so that an employee accessing his shift information will see and print only the punch ins and punch outs he considers for the current week.

In one embodiment, the POS terminal 210 transmits employee shift information (clock times and associated employee information) via the communications port (not shown) to an intermediate server 214. The POS terminal 210 may automatically transmit the employee shift information as the employee enters the information or upon the close of a shift on a record by record basis or the POS terminal 210 may compile a plurality of the records for a period of time before transmitting the plurality of record to the intermediate server 214. The POS terminal 210 may also transmit the employee shift information upon instructions input at the POS terminal 210 or received from the intermediate server 214 or host server 220 where the POS terminal 210 is connected directly to the Internet 240.

The intermediate server system 214 receives the data or information from one or a plurality of POS devices. The intermediate server system 214 may store a portion of the data in a memory 250. The intermediate server system 214 may also verify the information and determine what type of services are available for the specific POS terminal. For example, the labor resource services of the present invention may be provided to a business on a subscription basis. The scope of the services provided to a specific business may vary depending on the specific subscription for that business. The intermediate server system 214 may identify which services are available for the received data based on the business associated with a specific POS terminal from which the intermediate server 214 receives data and may store, record or manipulate the data based on the associated services to which that business has subscribed. Similarly, the intermediate server 214 may transmit or upload data to the host server 220 via the Internet 240 according to the specific subscription. Alternatively, the intermediate server 214 may transmit or upload all the data or information for a business regardless of the subscription, and the host server 220 would perform the function of identifying the services available under the specific subscription for a business.

The host server 220 hosts user interface software for presenting an Internet web site through which end users 260 can access, manipulate, modify or request reports from the labor resource information. As discussed above, end users 260 may have different degrees of authorization for accessing the information. The host server 220 (and the intermediate server 214) are capable of segregating information from different points-of-sale or businesses so that only authorized users can access the information and so that the data from different businesses is not commingled. The Internet web site may provide a variety of functionality, including, but not limited to, registering the clock for a specific point-of-sale device, adjusting, adding and deleting clock entries (e.g., punch in and punch out clock times), assigning a dollar value to the employee hours worked, printing time cards, applying overtime rules, printing labor summary reports, uploading and downloading data for payroll, adjusting dollar value associated with employee hours, modifying location and department information and maintaining employee records, including adding or deleting employees and associated payroll and identifying information or modifying existing employee identifying information and pay scales.

In another embodiment, which does not include an intermediate server, the POS terminals communicate with the host server.

In this embodiment, the host server receives the data or information from one or a plurality of POS devices, and the host server performs the functions of storing and verifying the information. In a further embodiment, the host server may or may not determine the type of services that are available for the specific POS terminal. For example, the host server may identify which services are available for the received data based on the business associated with a specific POS terminal from which the host server receives data and may store, record or manipulate the data based on the associated services to which that business has subscribed.

In addition to accessing information via the Internet web site, a manager may also access the labor resource information via the POS terminal 210. The manager may enter identifying information and a secure identifier such as a password or series of key strokes at the POS terminal 210. After entering the secure identifier, a plurality of management functions would be available to the manager via the inputs and display device of the POS terminal 210. Such management functions may include, without limitation, opening and closing a payroll week, printing employee time summaries, adjusting employee time entries, adding/editing system parameters and requesting reports. The manager may also have the ability to change the secure identifier, e.g., change the password or set of key strokes.

The managerial functions may also be available to the manager on a plurality of other Internet enabled devices such as a PDA, cellular telephone, personal computer, smart card device or the like.

Businesses that would benefit from the system and method of time and attendance record keeping according to the present invention include those businesses that would ordinarily have POS devices and hourly employees such as retail shops, hospitality medical and oil & gas businesses, government agencies.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of recording employee time records, comprising:
receiving identifying information from an employee at a point-of-sale terminal;
recording clock in data for the employee;
recording clock out data for the employee, wherein each clock out datum corresponds to a single clock in datum, and;
using the clock in data and the clock out data to produce a time record for the employee;
validating said clock in and clock out data; and
transmitting the time record to a host system via a communication network,

2. The method of claim 1, wherein said validating comprises:
identifying the successive recording of two or more clock in data or two or more clock out data without intervening clock out data or clock in data, respectively, as an error;
identifying an unusually long time duration between a clock in datum and a corresponding clock out datum as an error.

3. The method of claim 1, wherein the recording of clock in and clock out data is accomplished by a POS terminal.

4. The method of a claim 3, wherein the POS terminal communicates the clock in and clock out data to a host server, wherein said using the clock in data and the clock out data to produce a time record for the employee is accomplished by said host server.
